(19) United States
(12) Patent Application Publication
(10) Pub. No.: US 2023/0289912 A1
(43) Pub. Date: Sep. 14, 2023

(54) INTELLIGENT DISASTER MANAGEMENT METHOD AND DEVICE USING SATELLITE IMAGE

(71) Applicant: ELECTRONICS AND TELECOMMUNICATIONS RESEARCH INSTITUTE, Daejeon (KR)

(72) Inventors: Yong Mun PARK, Daejeon (KR); Tae-Gun KANG, Daejeon (KR); Sang-il KIM, Sejong-si (KR); Seung Chul KIM, Daejeon (KR); Do-Seob AHN, Daejeon (KR); Joon Gyu RYU, Daejeon (KR); Jeom Hun LEE, Daejeon (KR)

(73) Assignee: ELECTRONICS AND TELECOMMUNICATIONS RESEARCH INSTITUTE, Daejeon (KR)

(21) Appl. No.: 18/079,647

(22) Filed: Dec. 12, 2022

(30) Foreign Application Priority Data
Mar. 11, 2022 (KR) 10-2022-0030881

(51) Int. Cl. G06Q 50/26; G06V 20/13; G06V 10/82

(52) U.S. Cl. CPC G06Q 50/265; G06V 20/13; G06V 10/82

(57) ABSTRACT

Provided is an intelligent disaster management method and an apparatus using a satellite image. The disaster management method includes receiving a satellite image to monitor a disaster, setting a location of an area for disaster monitoring and a type of disaster to be monitored and selecting at least one satellite image associated with the location of the area and the type of disaster among the received satellite images through a satellite image selection model, synthesizing the selected satellite images through a satellite image synthesis model and generating disaster image data which enables to monitor a disaster, and monitoring a disaster of the area for disaster monitoring by using the disaster image data.

### CROSS-REFERENCE TO RELATED APPLICATION

This application claims the benefit of Korean Patent Application No. 10-2022-0030881 filed on Mar. 11, 2022, in the Korean Intellectual Property Office, the entire disclosure of which is incorporated herein by reference for all purposes.

### BACKGROUND

### 1. Field of the Invention

One or more example embodiments relate to a disaster management method and apparatus. More specifically, one or more embodiments relate to a disaster management method and apparatus for monitoring disasters based on the area and type of disaster by using a satellite image and artificial intelligence.

### 2. Description of the Related Art

The type and amount of data associated with various types of satellites and disasters are increasing. Expectations are increasing to create much value by collecting such various types of data and analyzing the same. However, in existing disaster monitoring methods, accuracy and efficiency are reduced depending on which data is used among the various types of data. In this regard, it is necessary to select data associated with a certain disaster and develop technology for improving the accuracy and efficiency of monitoring a disaster by using the data.

### SUMMARY

Example embodiments provide an intelligent disaster management method and apparatus for setting a location of an area for disaster monitoring and a type of disaster to be monitored, selecting at least one satellite image associated with the location of the area for disaster monitoring and the type of disaster to be monitored among the satellite images, and utilizing a satellite image for generating disaster image data by synthesizing the selected images.

According to an aspect, there is provided a disaster management method including receiving a satellite image to monitor a disaster, setting a location of an area for disaster monitoring and a type of disaster to be monitored and selecting at least one satellite image associated with the location of the area and the type of disaster among the received satellite images through a satellite image selection model, synthesizing the selected satellite images through a satellite image synthesis model and generating disaster image data which enables to monitor a disaster, and monitoring a disaster of the area for disaster monitoring by using the disaster image data.

The satellite image selection model may be trained to select a satellite image of which at least one of a capture angle, geographic coordinates, and a capture time point included in each of the satellite images is associated with the location of the area.

The satellite image selection model may be trained to select a satellite image associated with the type of disaster based on a specification of the satellite image.

The satellite image synthesis model may select any one of the selected satellite images as a reference satellite image, be trained to match at least one of a resolution, a magnification, a focus, a view angle, and a window size of the rest of the selected satellite images to the reference satellite image, and synthesize the matched satellite image.

The monitoring of the disaster may include monitoring the disaster by analyzing whether a disaster occurs, a degree of risk, and a degree of damage in the area for disaster monitoring by comparing the disaster image data generated before and after a predetermined time point.

According to an aspect, there is provided a disaster management apparatus for performing a disaster management method, the disaster management apparatus including a processor. The processor may receive a satellite image to monitor a disaster, set a location of an area for disaster monitoring and a type of disaster to be monitored and select at least one satellite image associated with the location of the area and the type of disaster among the received satellite images through a satellite image selection model, synthesize the selected satellite images through a satellite image synthesis model and generate disaster image data which enables to monitor a disaster, and monitor a disaster of the area for disaster monitoring by using the disaster image data.

The satellite image selection model may be trained to select a satellite image of which at least one of a capture angle, geographic coordinates, and a capture time point included in each of the satellite images is associated with the location of the area.

The satellite image selection model may be trained to select a satellite image associated with the type of disaster based on a specification of the satellite image.

The satellite image synthesis model may select any one of the selected satellite images as a reference satellite image, be trained to match at least one of a resolution, a magnification, a focus, a view angle, and a window size of the rest of the selected satellite images to the reference satellite image, and synthesize the matched satellite image.

The monitoring of the disaster may include analyzing whether a disaster occurs, a degree of risk, and a degree of damage in the area for disaster monitoring by comparing the disaster image data generated before and after a predetermined time point.

Additional aspects of example embodiments will be set forth in part in the description which follows and, in part, will be apparent from the description, or may be learned by practice of the disclosure.

According to example embodiments, provided are an intelligent disaster management method and apparatus for setting a location of an area for disaster monitoring and a type of disaster to be monitored, selecting at least one satellite image associated with the location of the area for disaster monitoring and the type of disaster to be monitored among the satellite images, and utilizing a satellite image for generating disaster image data by synthesizing the selected images.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a disaster management apparatus according to an example embodiment;

FIG. 2 is a flowchart illustrating a disaster management method according to an example embodiment;

FIG. 3 is a diagram illustrating a training of a satellite image selection model and a satellite image synthesis model according to an example embodiment; and

FIG. 4 is a diagram illustrating a generation of disaster image data through the satellite image selection model and the satellite image synthesis model according to an example embodiment.

### DETAILED DESCRIPTION

Hereinafter, example embodiments will be described in detail with reference to the accompanying drawings. The scope of the right, however, should not be construed as limited to the example embodiments set forth herein. In the drawings, like reference numerals are used for like elements.

Various modifications may be made to the example embodiments. Here, the example embodiments are not construed as limited to the disclosure and should be understood to include all changes, equivalents, and replacements within the idea and the technical scope of the disclosure.

The terminology used herein is for the purpose of describing particular example embodiments only and is not to be limiting of the example embodiments. As used herein, the singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the examples with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

Hereinafter, example embodiments will be described in detail with reference to the accompanying drawings.

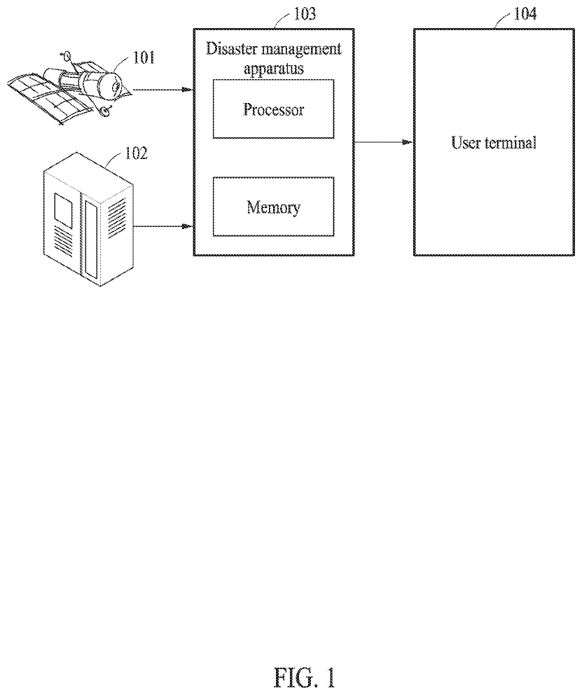

FIG. 1 is a diagram illustrating a disaster management apparatus according to an example embodiment.

A disaster management method according to an example embodiment of the present disclosure is performed by a disaster management apparatus 103.

The disaster management apparatus 103 may receive a satellite image from at least one satellite 101 or a server 102, which provides at least one satellite image.

Here, the satellite 101 may be a geostationary orbit satellite, a low orbit satellite, or an image radar (synthetic aperture radar, SAR) satellite. The satellite 101 may include various satellites, such as domestic or overseas satellites. The satellite image may be raw data received from the satellite 101. If the satellite 101 is a satellite which does not perform communication directly, the disaster management apparatus 103 may receive a satellite image from the server 102, which provides satellite images.

The disaster management apparatus 103 may receive a satellite image in real time from the satellite 101, capable of capturing a certain area in real time, such as a geostationary orbit satellite. The disaster management apparatus 103 may periodically receive a satellite image from the satellite 101 orbiting the earth by a predetermined period. In addition, when disaster management is necessary, the disaster management apparatus 103 may receive the necessary satellite image through communication with the satellite 101 or the server 102 providing the satellite image.

The disaster management apparatus 103 may store the received satellite image. The disaster management apparatus 103 may monitor the disaster by using the stored satellite image. Alternatively, the disaster management apparatus 103 may provide the stored satellite image to a user terminal 104, which needs the satellite image. The disaster management apparatus 103 may store the disaster image data, disaster monitoring result, information about past disasters, and others.

The disaster management apparatus 103 may set the location of the area to be monitored and the type of disaster to be monitored and input the same to a satellite image selection model. The disaster management apparatus 103 may select at least one satellite image associated with the location of the area to be monitored and the type of disaster to be monitored from among the plurality of satellite images through the satellite image selection model.

The disaster management apparatus 103 may generate the disaster image data which enables to monitor a disaster by synthesizing the satellite images selected through the satellite image synthesis model. The disaster image data may be data appropriately processed for disaster monitoring. The disaster image data may be data in which the boundaries between various kinds of geography (e.g., mountains, water, cities, and land) included in the satellite image are divided by weight.

The disaster management apparatus 103 may use the generated disaster image data to monitor the disaster in the area. The disaster management apparatus 103 may monitor the disaster based on the area and type of disaster by using the generated disaster image data.

The disaster management apparatus 103 may monitor the disaster by analyzing whether a disaster occurs, a degree of risk, and a degree of damage in the area for disaster monitoring by comparing the disaster image data generated before and after a predetermined time point.

The disaster management apparatus 103 may monitor the disaster by using not only disaster image data but also data associated with other types of disasters. For example, the disaster management apparatus 103 may use image data received from a device installed on the ground, observation data, measurement data of the system measuring the disaster, and big data associated with the disaster received through a communication network.

The disaster management apparatus 103 may monitor a plurality of types of disasters. The disaster management apparatus 103 may divide the area for disaster monitoring by dividing the area into a plurality of areas. In addition, the disaster management apparatus 103 may sequentially or simultaneously monitor each area.

The disaster management apparatus 103 may provide the disaster monitoring result to the user terminal 104. The user terminal 104 may be a terminal of the users located in the area in which damage caused by the disaster is expected or a terminal of an organization associated with the disaster. The disaster management apparatus 103 may periodically provide the disaster monitoring result to the user terminal 104 or in real time. The disaster management apparatus 103 may store the disaster monitoring result and use the disaster monitoring result to manage a disaster thereafter.

When a disaster is detected, the disaster management apparatus 103 may enable people to leave the area in which damage is expected through the user terminal 104 located in the area in which damage caused by the disaster is expected. In addition, when a disaster situation is detected, the disaster management apparatus 103 may provide information of the disaster to an organization associated with the disaster to enable countermeasures.

The disaster management apparatus 103 may output the disaster monitoring result. The disaster management apparatus 103, when a disaster occurs, may not only provide an image output but also an alarm notifying that a disaster occurs through an audio output.

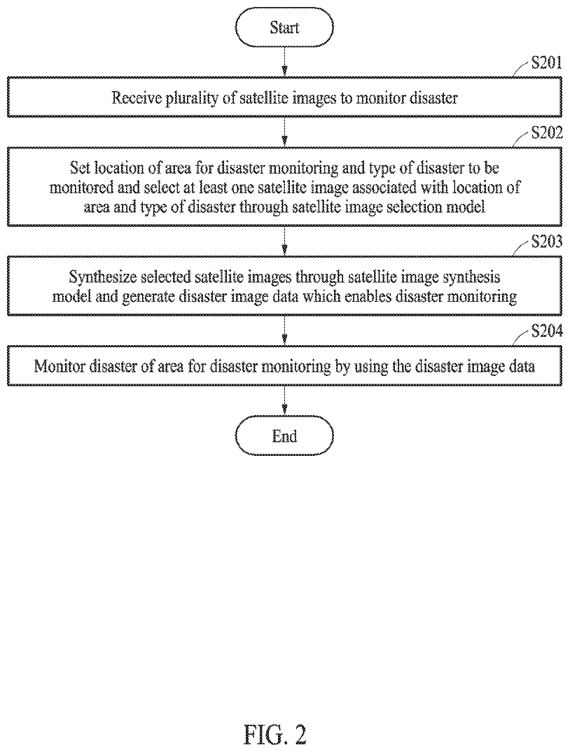

FIG. 2 is a flowchart illustrating a disaster management method according to an example embodiment.

In operation S201, the disaster management apparatus 103 may receive a satellite image to monitor the disaster. The disaster management apparatus 103 may receive a satellite image from at least one satellite 101 or a server 102, which provides at least one satellite image.

In operation S202, the disaster management apparatus 103 may set the location of the area to be monitored and the type of disaster to be monitored and select at least one satellite image associated with the location of the area and the type of disaster among the satellite images through the satellite image selection model. A satellite image selection model 302 may be trained to select at least one satellite image associated with the location of the area to be monitored and the type of disaster to be monitored among satellite images of various types and various time points.

In operation S203, the disaster management apparatus 103 may generate disaster image data which enables to monitor a disaster by synthesizing selected satellite images through the satellite image synthesis model. The satellite image synthesis model may be trained to generate disaster image data which enables to monitor a disaster by synthesizing the selected satellite images.

In operation S204, the disaster management apparatus 103 may monitor the disaster in the area for disaster monitoring by using the disaster image data. The disaster management apparatus 103 may analyze whether a disaster occurs, a degree of risk, and a degree of damage in the area for disaster monitoring by comparing the disaster image data generated before and after a predetermined time point. The disaster management apparatus 103 may provide the disaster monitoring result to the user terminal 104.

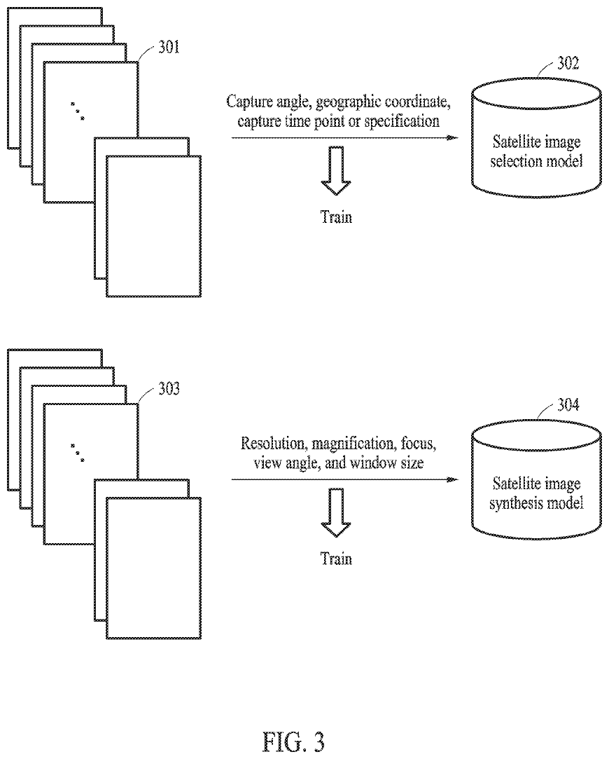

FIG. 3 is a diagram illustrating a training of a satellite image selection model and a satellite image synthesis model according to an example embodiment.

The selecting of the disaster management apparatus 103 of satellite images necessary for monitoring associated with the location of the area for disaster monitoring and the type of disaster to be monitored from various types of many satellite images generated from the satellites may have a big impact on the efficiency and accuracy of the disaster monitoring result.

Therefore, in order to manage various disasters, there is a need for the disaster management apparatus 103 to efficiently select the satellite images, synthesize the selected satellite images, and generate disaster image data.

Accordingly, the disaster management apparatus 103 may use artificial intelligence when selecting a satellite image for disaster monitoring. Among artificial intelligence, deep learning may generate disaster image data by selecting the satellite images by using a deep neural network (DNN) including an algorithm derived through repetitive training and synthesizing the selected satellite images.

Specifically, the satellite image selection model 302 may select at least one satellite image among received satellite images according to the location of the area to be monitored and the type of disaster to be monitored. The satellite image synthesis model 304 may generate disaster image data which enables to monitor a disaster by synthesizing the selected satellite images. Here, the satellite image selection model 302 and the satellite image synthesis model 304 may each be a DNN trained to select the satellite images and to generate disaster image data.

Satellite images received for disaster monitoring may include different information. The satellite images may include a satellite image including a lot of information of a specific area. The satellite images may include satellite images having different information according to the type of disaster. Accordingly, the satellite image selection model 302 may be trained to select at least one satellite image associated with the location of the area to be monitored and the type of disaster to be monitored from the satellite images.

According to an example embodiment of the present disclosure, the satellite image necessary for disaster monitoring may be different according to the type and stage of the disaster.

The capture angle, the geographic coordinates, and the capture time point included in a training satellite image 301 may become a reference for selecting the satellite images necessary according to the type and location of the disaster. Accordingly, the satellite image selection model 302 may be trained through artificial intelligence technology to select satellite images of which at least one of the capture angle, the geographic coordinates, and the capture time point, included in each training satellite image 301, is associated with the location of the area to be monitored. The satellite image selection model 302 may select the satellite images by using the DNN including an algorithm derived through repetitive training.

According to another example embodiment of the present disclosure, the satellite image selection model 302 may be trained to select the satellite image associated with the type of disaster, based on the specification of the training satellite image 301. The specification of a satellite image may refer to the characteristics of each satellite, such as resolution, view angle, magnification, and focus.

The satellite image synthesis model 304 may synthesize the selected satellite images. Here, accuracy may decrease when the satellite image synthesis model 304 immediately performs synthesis according to the orbit, capture time point, and specification of the satellite which captured the selected satellite images. Therefore, a process of matching the different selected satellite images may be necessary before the satellite image synthesis model synthesizes the selected satellite images.

Accordingly, according to an example embodiment of the present disclosure, the satellite image synthesis model 304 may select any one of the selected training satellite images 303 as the reference satellite image. The satellite image synthesis model 304 may be trained to match at least one of the resolution, magnification, focus, view angle, and window size of the rest of the selected training satellite images except for the reference satellite image with the reference satellite image. Due to the different characteristics of the satellites, the satellite image synthesis model 304 may be trained to perform preprocessing and correction to match the information of the rest of the satellite images except for the reference satellite image with the reference satellite image when synthesizing the satellite images. In addition, the satellite image synthesis model 304 may generate disaster image data by synthesizing the matched satellite images.

The reference satellite image may be a predetermined type of satellite image. The reference satellite image may be set based on the difference with other satellite images. The reference satellite image may be set or selected by the user.

In this way, the disaster management apparatus 103 may increase the accuracy of the disaster image data through the trained satellite image selection model 302 and the trained satellite image synthesis model 304.

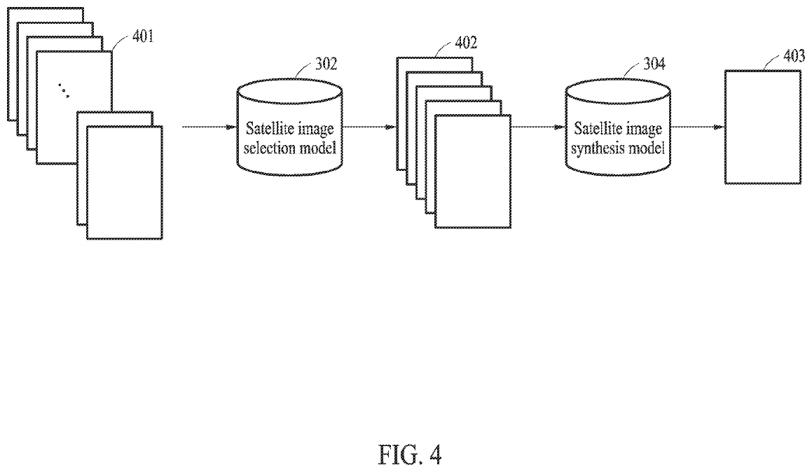

FIG. 4 is a diagram illustrating a generation of disaster image data through the satellite image selection model and the satellite image synthesis model according to an example embodiment.

The disaster management apparatus 103 may receive satellite images 401 for disaster monitoring. The disaster management apparatus 103 may receive satellite images 401 from at least one satellite 101 or the server 102 which provides at least one satellite image.

The satellite image selection model 302 may select a satellite image of which at least one of the capture angle, the geographic coordinates, and the capture time point included in each of the satellite images 401 is associated with the location of the area to be monitored.

The satellite image selection model 302 may select the satellite image associated with the type of disaster, based on the specification of the satellite images 401.

The satellite image synthesis model 304 may generate the disaster image data which enables to monitor a disaster by synthesizing selected satellite images 402.

The satellite image synthesis model 304 may select any one of the selected satellite images 402 as the reference satellite image and match at least one of the resolution, magnification, focus, view angle, and window size of the rest of the selected satellite images to the reference satellite image. In addition, the satellite image synthesis model 304 may generate the disaster image data 403 which enables to monitor a disaster by synthesizing the matched satellite images. The disaster image data 403 may be data in which the boundaries between various kinds of geography (e.g., mountains, water, cities, and land) included in the satellite image are divided by weight. The disaster management apparatus 103 may monitor the disaster according to area and type of disaster by using the disaster image data 403 generated from the satellite image synthesis model 304.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductive wire memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

Although the present specification includes details of a plurality of specific example embodiments, the details should not be construed as limiting any invention or a scope that can be claimed, but rather should be construed as being descriptions of features that may be peculiar to specific example embodiments of specific inventions. Specific features described in the present specification in the context of individual example embodiments may be combined and implemented in a single example embodiment. On the contrary, various features described in the context of a single example embodiment may be implemented in a plurality of example embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In addition, it should not be understood that the separation of various device components of the aforementioned example embodiments is required for all the example embodiments, and it should be understood that the aforementioned program components and apparatuses may be integrated into a single software product or packaged into multiple software products.

The example embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed example embodiments, can be made.

What is claimed is:

1. A disaster management method comprising:
receiving a satellite image to monitor a disaster;
setting a location of an area for disaster monitoring and a type of disaster to be monitored and selecting at least one satellite image associated with the location of the area and the type of disaster among the received satellite images through a satellite image selection model;
synthesizing the selected satellite images through a satellite image synthesis model and generating disaster image data which enables to monitor a disaster; and
monitoring a disaster of the area for disaster monitoring by using the disaster image data.

2. The disaster management method of claim 1, wherein the satellite image selection model is trained to select a satellite image of which at least one of a capture angle, geographic coordinates, and a capture time point included in each of the satellite images is associated with the location of the area.

3. The disaster management method of claim 1, wherein the satellite image selection model is trained to select a satellite image associated with the type of disaster based on a specification of the satellite image.

4. The disaster management method of claim 1, wherein the satellite image synthesis model selects any one of the selected satellite images as a reference satellite image, is trained to match at least one of a resolution, a magnification, a focus, a view angle, and a window size of the rest of the selected satellite images to the reference satellite image and generates disaster image data by synthesizing the matched satellite image.

5. The disaster management method of claim 1, wherein the monitoring of the disaster comprises monitoring the disaster by analyzing whether a disaster occurs, a degree of risk, and a degree of damage in the area for disaster monitoring by comparing the disaster image data generated before and after a predetermined time point.

6. A disaster management apparatus for performing a disaster management method, the disaster management apparatus comprising a processor,
wherein the processor is configured to:
receive a satellite image to monitor a disaster;
set a location of an area for disaster monitoring and a type of disaster to be monitored and select at least one satellite image associated with the location of the area and the type of disaster among the received satellite images through a satellite image selection model;
synthesize the selected satellite images through a satellite image synthesis model and generate disaster image data which enables to monitor a disaster; and
monitor a disaster of the area for disaster monitoring by using the disaster image data.

7. The disaster management apparatus of claim 6, wherein the satellite image selection model is trained to select a satellite image of which at least one of a capture angle, geographic coordinates, and a capture time point included in each of the satellite images is associated with the location of the area.

8. The disaster management apparatus of claim 6, wherein the satellite image selection model is trained to select a satellite image associated with the type of disaster based on a specification of the satellite image.

9. The disaster management apparatus of claim 6, wherein the satellite image synthesis model selects any one of the selected satellite images as a reference satellite image, is trained to match at least one of a resolution, a magnification, a focus, a view angle, and a window size of the rest of the selected satellite images to the reference satellite image and generates disaster image data by synthesizing the matched satellite image.

10. The disaster management apparatus of claim 6, wherein the processor is configured to analyze whether a disaster occurs, a degree of risk, and a degree of damage in the area for disaster monitoring by comparing the disaster image data generated before and after a predetermined time point.
